(19) United States
(12) Patent Application Publication
(10) Pub. No.: US 2013/0340561 A1
(43) Pub. Date: Dec. 26, 2013

(54) LINKAGE MECHANISM FOR PHYSICAL MULTI-CONTACT INTERACTION

(71) Applicant: KOREA INSTITUTE OF SCIENCE AND TECHNOLOGY, Seoul (KR)

(72) Inventors: Do Ik KIM, Seoul (KR); Sang Ik AN, Seoul (KR)

(21) Appl. No.: 13/927,590

(22) Filed: Jun. 26, 2013

(30) Foreign Application Priority Data
Jun. 26, 2012 (KR) 10-2012-0068612

(51) Int. Cl. B25J 13/00

(52) U.S. Cl. CPC B25J 13/00; Y10S 901/02
USPC 74/490.12; 901/2

(57) ABSTRACT

A linkage mechanism is coupled to a limb of a human including a second body articulated to a first body and a third body articulated to the second body and has a plurality of link arms and a plurality of connection units for connecting the link arms to be adaptively movable according to a motion of the human, and an upper fixing portion and a lower fixing portion for fixing the linkage mechanism to the second body and the third body, wherein all or a part of the link arms are connected to each other to form a closed loop including the upper fixing portion and the lower fixing portion together with the second body and the third body, wherein actuators are provided to the connection units, and wherein the actuators are selectively operated to apply a force selectively to the upper fixing portion and the lower fixing portion.

### CROSS-REFERENCE TO RELATED APPLICATION

This application claims priority to Korean Patent Application No. 10-2012-0068612, filed on Jun. 26, 2012, and all the benefits accruing therefrom under 35 U.S.C. §119, the contents of which in its entirety are herein incorporated by reference.

### BACKGROUND

1. Field

The present disclosure relates to a linkage mechanism, and more particularly, to a linkage mechanism capable of feeding contact information, applied to a physically connected robot at a remote place or a target in a virtual environment, back to a user precisely.

2. Description of the Related Art

A system that physically connects a human to a robot at a remote place or a target in a virtual environment so that the robot or target imitates the human and feeds a stimulus such as an external force, applied to the robot or target, back to the human has been studied.

In the conventional art, a robot remote control system using an arm-attached tool has been proposed, but a method of feeding an external force, applied to a robot, back to the human has not been proposed.

In addition, as a method of feeding an external force or the like, applied to a robot, back to a human, there is known a method of transferring a force to a terminal such as the fingertip of a human. However, in this method, it is impossible to figure out a portion of the robot arm with a multi-joint structure to which an external force is applied, and so there is a limit in checking an accurate status of a robot at a remote place.

### SUMMARY

The present disclosure is directed to providing a linkage mechanism, which is mechanically restricted to a human at several points to move together and generates a force to a connection portion so that a contact status of a target at a remote place or in a remote environment may be checked.

In one aspect, there is provided a linkage mechanism, which is coupled to a limb of a human including a second body articulated to a first body and a third body articulated to the second body, and includes: a plurality of link arms and a plurality of connection units for connecting the link arms to be adaptively movable according to a motion of the human; and an upper fixing portion and a lower fixing portion for fixing the linkage mechanism to the second body and the third body, wherein all or a part of the plurality of link arms are connected to each other to form a closed loop including the upper fixing portion and the lower fixing portion together with the second body and the third body, wherein actuators for generating power are provided to the plurality of connection units, and wherein the actuators are selectively operated to apply a force selectively to the upper fixing portion and the lower fixing portion.

The linkage mechanism may be a linkage mechanism for remotely controlling a limb of a robot including a second robot body articulated to a first robot body and a third robot body articulated to the second robot body, the linkage mechanism may be controlled to apply a force to the upper fixing portion when an external force is applied to the second robot body, and the linkage mechanism may be controlled to apply a force to the lower fixing portion when an external force is applied to the third robot body.

The link arm connected to the upper fixing portion and the link arm connected to the lower fixing portion may be connected to each other to form a closed loop.

The link arm connected to the upper fixing portion and the link arm connected to the lower fixing portion may be connected via another link arm to form a closed loop.

The link arm connected to the upper fixing portion and the link arm connected to the lower fixing portion may be connected through link arms connected to a connection unit which fixes the linkage mechanism to a support surface, and a closed loop including the upper fixing portion, the lower fixing portion and the connection unit for fixing the linkage mechanism to the support member may be formed.

The plurality of connection units may include a displacement measuring sensor for measuring a displacement of the connection unit.

The plurality of connection units may be each a hinge-type connection unit which connects two link arms by a hinge, and the actuator may be a torque actuator for rotating the hinge-type connection unit to generate a torque.

The plurality of connection units may be each a cylindrical connection unit where a link arm is inserted into a cylinder of another link arm so that both link arms are linearly movable, and the actuator may be a length actuator for restricting movement of the link arm inserted into the cylinder.

The plurality of connection units may be configured as a combination of a hinge-type connection unit which connects two link arms to each other by a hinge and a cylindrical connection unit where a link arm is inserted into a cylinder of another link arm so that both link arms are linearly movable, and the actuator may be a torque actuator for rotating the hinge-type connection unit to generate a torque or a length actuator for restricting movement of the link arm inserted into the cylinder.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram showing a linkage mechanism according to an embodiment of the present disclosure, which is coupled to the arm of a human;

FIG. 2 is a diagram showing a robot arm operated by using the linkage mechanism of FIG. 1;

FIG. 3A is a diagram showing a linkage mechanism according to another embodiment of the present disclosure;

FIG. 3B is a diagram showing a robot arm operated by using the linkage mechanism of FIG. 3A;

FIG. 4A is a diagram showing a linkage mechanism according to another embodiment of the present disclosure;

FIG. 4B is a diagram showing a robot arm operated by using the linkage mechanism of FIG. 4A;

FIG. 5 is a diagram showing a linkage mechanism according to another embodiment of the present disclosure;

FIGS. 6A and 6B are diagrams showing a linkage mechanism according to another embodiment of the present disclosure;

FIGS. 7A to 7F are diagrams showing a linkage mechanism according to another embodiment of the present disclosure; and

FIGS. 8 and 9 are schematic diagrams showing the linkage mechanism according to an embodiment of the present disclosure, worn by a user.

### DETAILED DESCRIPTION

Hereinafter, exemplary embodiments of the present disclosure will be described with reference to the accompanying drawings. Even though the present disclosure is described with reference to the embodiment shown in the drawings, it is just an example, and the technical spirit of the present disclosure and its essential components and operations are not limited thereto.

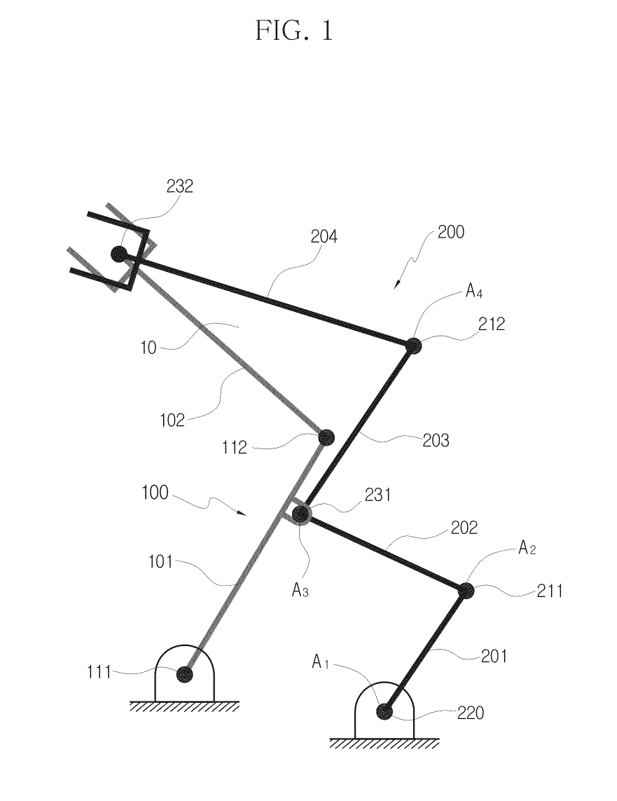

FIG. 1 shows a linkage mechanism 200 according to an embodiment of the present disclosure, which is coupled to the arm 100 of a user.

Even though the arm is depicted among various kinds of limbs, the present disclosure is not limited thereto.

In FIG. 1, the arm 100 is depicted in brief as a two-link structure including an upper arm 101 articulated to a shoulder joint 111 and a forearm 102 articulated to the upper arm 101 by an elbow joint 112.

Hereinafter, for convenience, the shoulder will be called a first body, the upper arm 101 will be called a second body, the forearm 102 will be called a third body, the shoulder joint 111 will be called an upper joint, the elbow joint 112 will be called a lower joint.

Here, the term “upper” means a location near the body of a human, and the term “lower” means a location far from the body of a human.

Meanwhile, according to this embodiment, even though the shoulder is called the first body, the upper arm 101 is called the second body, the forearm 102 is called the third body, the shoulder joint 111 is called the upper joint, and the elbow joint 112 is called the lower joint, these terms are not limited to the corresponding portions. For example, if the upper arm is called a first body, the forearm will be a second body, and the hand will be a third body. In addition, the upper joint will be an elbow joint, and the lower joint will be a wrist joint.

In addition, the linkage mechanism of this embodiment may be connected to the leg of a human, and the terms such as the first body may be suitably selected to correspond to each portion of the leg with reference to the above.

As shown in FIG. 1, the linkage mechanism 200 includes a plurality of link arms 201, 202, 203, 204 and connection units 211, 212, 220, 231 for connecting two link arms to each other.

Meanwhile, the linkage mechanism 200 includes an upper fixing portion 231 and a lower fixing portion 232 at the second body 101 and the third body 102. In this embodiment, the upper fixing portion 231 also plays a role of a connection unit which connects two link arms 202, 203.

The joints, the connection units and the fixing portions, depicted as thick points in FIG. 1, may make hinge movement, and a person having ordinary skill in the art may understand that the link arms may adaptively move according to a motion of a human unless an external force is applied thereto.

There are provided four link arms: namely first to fourth link arms 201, 202, 203, 204. Among them, the third link arm 203 and the fourth link arm 204 are respectively joint-connected to the upper fixing portion 231 and the lower fixing portion 232, and also joint-connected to each other at the second connection unit 212.

In other words, the third link arm 203 and the fourth link arm 204 are connected to form a closed loop 10 including the upper fixing portion 231 and the lower fixing portion 232 together with the second body 101 and the third body 102. Meanwhile, the first link arm 201 and the second link arm 202 are connected to form a closed loop connecting the connection units 231, 211, 220 and the shoulder joint 111 together with the second body 101. Therefore, the link mechanism of this embodiment is attached to the arm of a user in a state where two closed loops are connected in parallel.

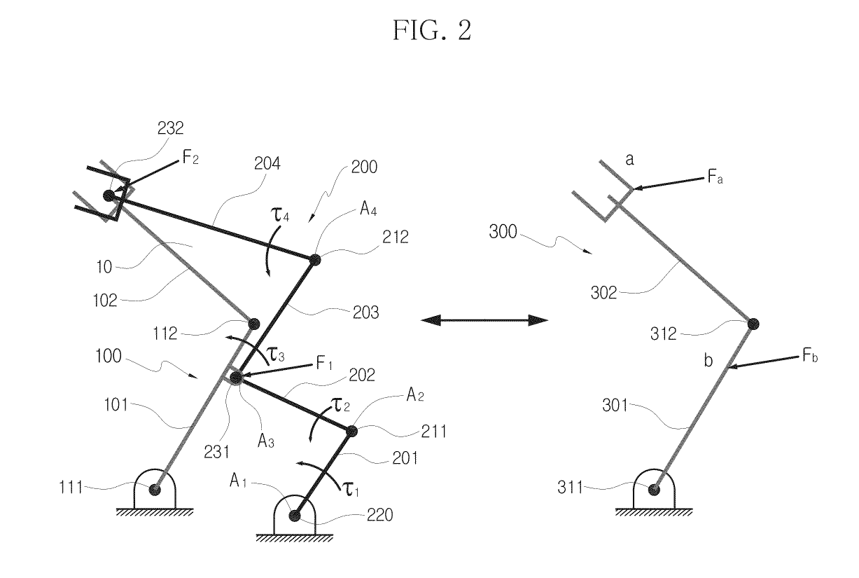

FIG. 2 shows a robot arm 300 operated by using the linkage mechanism 200 according to the embodiment of the present disclosure.

The linkage mechanism 200 is used for operating a robot arm 300 having substantially the same structure as the arm of a human as shown in FIG. 1. In detail, the robot arm 300 is a limb of a robot, which includes a second robot body 301 articulated to a first robot body (the lower portion of the joint portion 311 in FIG. 2) and a third robot body 302 articulated to the second robot body 301.

The connection unit 211, the connection unit 212 and the connection unit 231 include displacement measuring sensors (not shown) for measuring displacements of the corresponding connection units. In this embodiment, a rotating displacement measuring sensor for measuring a rotating displacement of the corresponding connection unit is used as the displacement measuring sensor.

If a rotating displacement of each connection unit 211, 212, 231 is measured, rotating displacements of the joint portions 111, 112 of the arm may be calculated by a mechanical relation between the arm 100 and the fixed linkage mechanism 200.

The rotating displacements of the joint portions 111, 112 of the arm are respectively transferred to the robot, and the joint portions 311, 312 of the robot arm are rotated at the same rotating angle by the actuators respectively mounted to the robot arms so that the robot arm operates while imitating the motion of the human arm.

According to this embodiment, the connection units 211, 212, 220, 231 of the linkage mechanism 200 includes torque actuators A1, A2, A3, A4 for generating torque and may selectively apply force to the upper fixing portion 231 and the lower fixing portion 232 by operating the actuators suitably.

The second robot body 301 and the third robot body 302 of the robot arm 300 include force sensors (not shown) for measuring a force applied to the corresponding robot body. In FIG. 2, if an external force (F_{b}) is applied at a point (b) of the second robot body 301 of the robot arm 300, the force sensor provided at the second robot body 301 measures the external force and sends information, informing of the intensity of the external force (F_{b}) and notifying that the external force (F_{b}) is a force applied to the second robot body 301, to a controller (not shown) of the linkage mechanism 200. In addition, if an external force (Fₐ) is applied at a point (a) of the third robot body 302, the force sensor provided at the third robot body 302 measures the external force and sends information, informing of the intensity of the external force (Fₐ) and notifying that the external force (Fₐ) is a force applied to the third robot body 302, to a controller (not shown) of the linkage mechanism 200.

The linkage mechanism 200 of this embodiment reproduces the external force (F_{b}) applied to the second robot body 301 of the robot arm 300 as a force (F₁) applied to the upper fixing portion 231 and reproduces the external force (Fₐ) applied to the third robot body 302 of the robot arm 300 as a force (F₂) applied to the lower fixing portion 232.

In detail, the static relation between the torques (i) of the connection units of the linkage mechanism 200 and the force (F) may be represented by Equation 1 below.

τ=J^{T}F Equation 1

Since the degree of freedom of the connection unit of the linkage mechanism 200 and the degree of freedom of the external force are respectively 4, Jacobian (J^{T}) has a dimension of 4×4. In other words, with respect to an external force, the torque of each joint has a one-to-one relation, and so all external forces may be expressed.

In the embodiment shown in FIG. 2, if Equation 1 is arranged based on the torque of each connection unit and the force to two fixing portions 231, 232 by means of the mechanical relation of the linkage mechanism 200, it may be expressed as Equation 2 below.

$$[ \begin{matrix}{τ}_{1} \\ {τ}_{2} \\ {τ}_{3} \\ {τ}_{4}\end{matrix} ] = [ \begin{matrix}{J}_{11} & {J}_{21} & {J}_{31} & {J}_{41} \\ {J}_{12} & {J}_{22} & {J}_{32} & {J}_{42} \\ 0 & 0 & {J}_{33} & {J}_{43} \\ 0 & 0 & {J}_{34} & {J}_{44}\end{matrix} ] [ \begin{matrix}{F}_{1 x} \\ {F}_{1 y} \\ {F}_{2 x} \\ {F}_{2 y}\end{matrix} ] \qquad Equation 2$$

In Equation 2, F₁ₓ and F_{1y} respectively represent x component and y component of F₁, and F₂ₓ and F_{2y} respectively represent x component and y component of F₂. In this embodiment, since the robot arm 300 and the human arm 100 are modeled as a two-dimensional operating mechanism, the force is expressed only with x component and y component. However in a case where the robot arm 300 and the human arm 100 are modeled as a three-dimensional operating mechanism, z component is added to expand Equation 2, as obvious to those having ordinary skill in the art.

In Equation 2, the item expressed by a text J is Jacobian representing a speed relation between the connection unit and the fixing portion, and such Jacobian may be obtained from the mechanical structure of the linkage mechanism 200 modeled as shown in FIG. 2, as obvious to those having ordinary skill in the art.

According to this embodiment, Equation 2 is used for calculating the torques applied by the actuators A1, A2, A3, A4 of the connection units.

First, if the force sensor measures that the external force (F_{b}) is applied only to the second robot body 301 of the robot arm 300, the controller (not shown) of the linkage mechanism 200 receives the information and scales the external force (F_{b}) at a preset ratio to calculate the force (F₁). At this time, the force (F₁) is calculated as x component (F₁ₓ) and y component (F_{1y}), respectively.

In this case, in Equation 2, since the F₂ component becomes 0, the torque (τ₃) and the torque (τ₄) become 0, and the torque (τ₁) and the torque (τ₂) are calculated.

Therefore, as shown in FIG. 2, the controller of the linkage mechanism 200 operates the actuator A1 to output the torque (τ₁) and operates the actuator A2 to output the torque (τ₂). Meanwhile, the controller does not operate the actuator A3 and the actuator A4.

By doing so, at the human arm 100, the force (F₁) is applied only to the upper fixing portion 231, and no force is applied to the lower fixing portion 232. Therefore, if force is applied only to the upper fixing portion 231, the user feels the force, and in this case, the user may understood that a force is applied to a point of the second robot body 301 of the robot arm 300 remotely controlled.

Next, if it is measured that the external force (Fₐ) is applied to the third robot body 302 of the robot arm 300, the controller (not shown) of the linkage mechanism 200 receives the information and scales the external force (Fₐ) at a preset ratio to calculate the force (F₂). At this time, the force (F₂) is calculated as x component (F₂ₓ) and y component (F_{2y}), respectively.

In this case, in Equation 2, the F₁ component becomes 0, but it may be understood that the torque (τ₁) and the torque (τ₂) do not become 0 and all of the torque (τ₁) to the torque (τ₄) may be calculated.

Therefore, the controller of the linkage mechanism 200 operates the actuator A1 to output the obtained torque (τ₁), operates the actuator A2 to output the obtained torque (τ₂), operates the actuator A3 to output the obtained torque (τ₃), and operates the actuator A4 to output the obtained torque (τ₄).

By doing so, in the human arm 100, the force (F₂) may be applied to the lower fixing portion 232, and no force may be applied to the upper fixing portion 231. Therefore, if the user feels this force, the user may understand that a force is applied to a point of the third robot body 302 of the robot arm 300 remotely controlled.

Finally, if it is measured that the external force (F_{b}) and the external force (Fₐ) are simultaneously applied to the second robot body 301 and the third robot body 302 of the robot arm 300, the controller (not shown) of the linkage mechanism 200 receives the information, scales the external force (F_{b}) at a preset ratio to calculate the force (F₁), and scales the external force (Fₐ) at a present ratio to calculate the force (F₂). At this time, the forces are respectively calculated as x component and y component.

In this case, all of the torque (τ₁) to the torque (τ₄) are calculated by Equation 2.

Therefore, the controller of the linkage mechanism 200 operates the actuator A1 to output the obtained torque (τ₁), operates the actuator A2 to output the obtained torque (τ₂), operates the actuator A3 to output the obtained torque (τ₃), and operates the actuator A4 to output the obtained torque (τ₄).

By doing so, the feeling of the force (F₁) applied to the upper fixing portion 231 and the feeling of the force (F₂) applied to the lower fixing portion 232 are transferred to the human arm 100. If the user feels the forces, the user may understand that forces are simultaneously applied to a point of the second robot body 301 and a point of the third robot body 302 of the robot arm 300 remotely controlled.

The above operations may also be implemented while changing the link configurations of the linkage mechanism 200 in various ways.

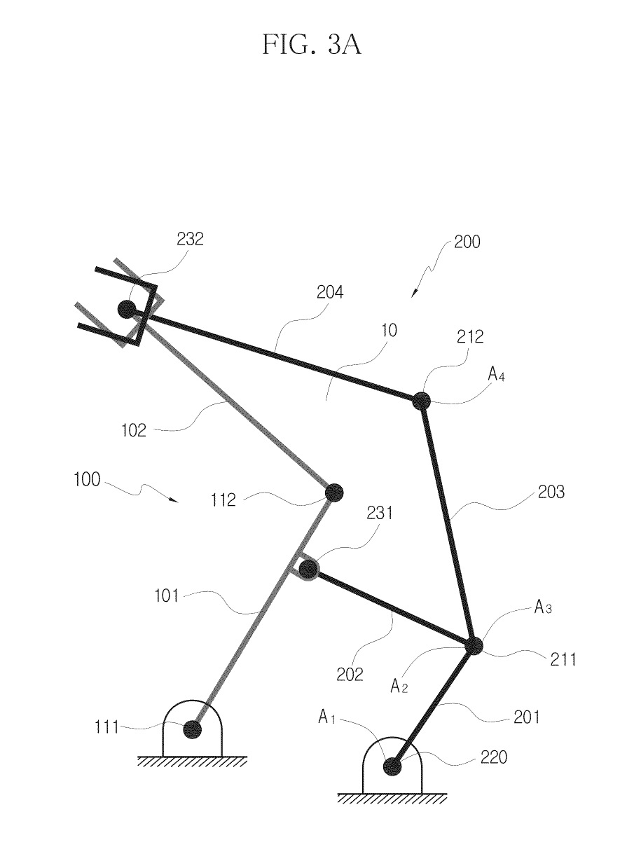

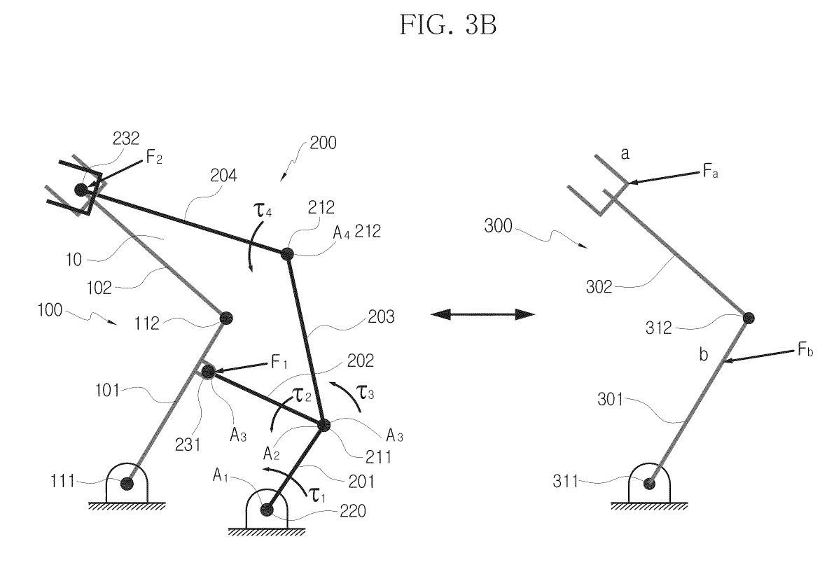

FIGS. 3A and 3B show a linkage mechanism 200 according to another embodiment of the present disclosure.

Referring to FIG. 3A, in the linkage mechanism 200 of this embodiment, the link arm 202 connected to the upper fixing portion 231 and the link arm 204 connected to the lower fixing portion 232 are connected to each other via another link arm 203 to form a closed loop 10. Meanwhile, the first link arm 201 and the second link arm 202 are connected to form a closed loop connecting the connection units 231, 211, 220 and the shoulder joint 111 together with the second body 101. Therefore, the linkage mechanism of this embodiment is attached to a user in a state where two closed loops are connected in parallel.

The connection unit 220 and the connection unit 212 respectively include a single actuator A1, A4, and the connection unit 211 includes two independent actuators A2, A3 together. In this embodiment, the upper fixing portion 231 does not have an actuator.

According to this embodiment, Equation 3 below is used for calculating a torque applied by the actuator A1, A2, A3, A4 of each connection unit.

$$[ \begin{matrix}{τ}_{1} \\ {τ}_{2} \\ {τ}_{3} \\ {τ}_{4}\end{matrix} ] = [ \begin{matrix}{J}_{11} & {J}_{21} & {J}_{31} & {J}_{41} \\ {J}_{12} & {J}_{22} & 0 & 0 \\ 0 & 0 & {J}_{33} & {J}_{43} \\ 0 & 0 & {J}_{34} & {J}_{44}\end{matrix} ] [ \begin{matrix}{F}_{1 x} \\ {F}_{1 y} \\ {F}_{2 x} \\ {F}_{2 y}\end{matrix} ] \qquad Equation 3$$

Referring to FIG. 3B, if the force sensor measures that the external force (F_{b}) is applied only to the second robot body 301 of the robot arm 300, the controller (not shown) of the linkage mechanism 200 receives information and scales the external force (F_{b}) at a preset ratio to calculate the force (F₁). At this time, the force (F₁) is calculated as x component (F₁ₓ) and y component (F_{1y}), respectively. By the relation of Equation 3, the controller (not shown) of the linkage mechanism 200 operates the actuator A1 to output the obtained torque (τ₁) and operates the actuator A2 to output the obtained torque (τ₂). Meanwhile, the actuator A3 and the actuator A4 are not operated.

By doing so, in the human arm 100, the force (F₁) is applied only to the upper fixing portion 231, and no force is applied to the lower fixing portion 232. Therefore, if the force is applied only to the upper fixing portion 231, the user may feel the force and thus may understand a point of the second robot body 301 of the robot arm 300 remotely adjusted, to which the force is applied.

Meanwhile, if it is measured that the external force (Fₐ) is applied to the third robot body 302 of the robot arm 300, the controller (not shown) of the linkage mechanism 200 receives the information and scales the external force (Fₐ) at a preset ratio to calculate the force (F₂). At this time, the force (F₂) is calculated as x component (F₂ₓ) and y component (F_{2y}), respectively.

In this case, in Equation 3, the F₁ component becomes 0 so that the torque (τ₂) becomes 0, and the torque (τ₁), the torque (τ₃) and the torque (τ₄) are calculated.

Therefore, the controller of the linkage mechanism 200 operates the actuator A1 to output the obtained torque (τ₁), operates the actuator A3 to output the obtained torque (τ₃), and operates the actuator A4 to output the obtained torque (τ₄). The actuator A2 is not operated.

By doing so, in the human arm 100, the force (F₂) may be applied to the lower fixing portion 232, and no force may be applied to the upper fixing portion 231. Therefore, if the user feels the force, the user may understand that a force is applied to a point of the third robot body 302 of the robot arm 300 remotely controlled.

Finally, if it is measured that the external force (F_{b}) and the external force (Fₐ) are simultaneously applied to the second robot body 301 and the third robot body 302 of the robot arm 300, the controller (not shown) of the linkage mechanism 200 calculates the force (F₁) and the force (F₂). At this time, the forces are respectively calculated as x component and y component.

In this case, all of the torque (τ₁) to the torque (τ₄) are calculated by Equation 3. Therefore, the controller of the linkage mechanism 200 operates the actuator A1 to output the obtained torque (τ₁), operates the actuator A2 to output the obtained torque (τ₂), operates the actuator A3 to output the obtained torque (τ₃), and operates the actuator A4 to output the obtained torque (τ₄).

By doing so, the feeling of the force (F₁) is applied to the upper fixing portion 231 and the feeling of the force (F₂) applied to the lower fixing portion 232 are transferred to the human arm 100. If the user feels the forces, the user may understand that forces are simultaneously applied to points of the second robot body 301 and the third robot body 302 of the robot arm 300 remotely controlled.

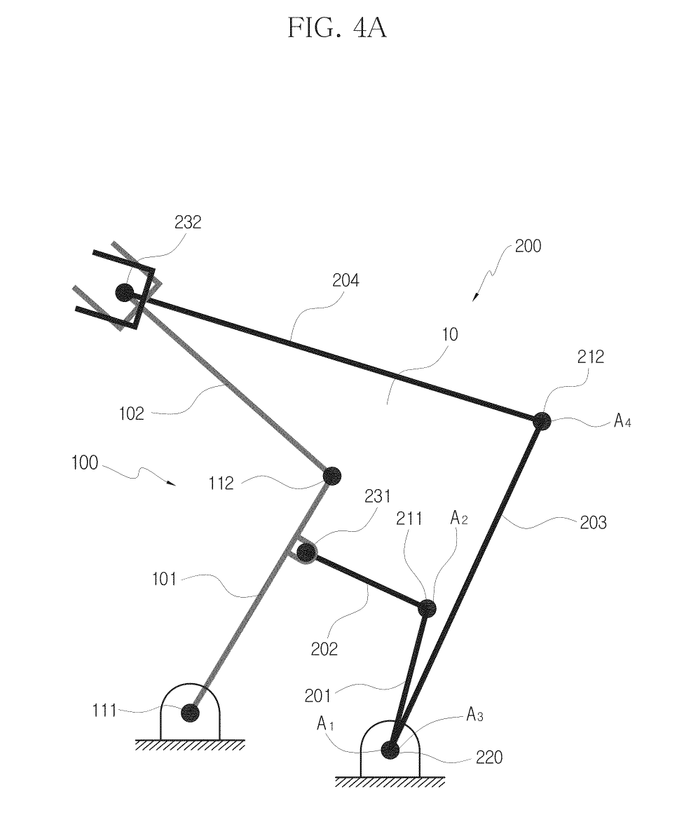

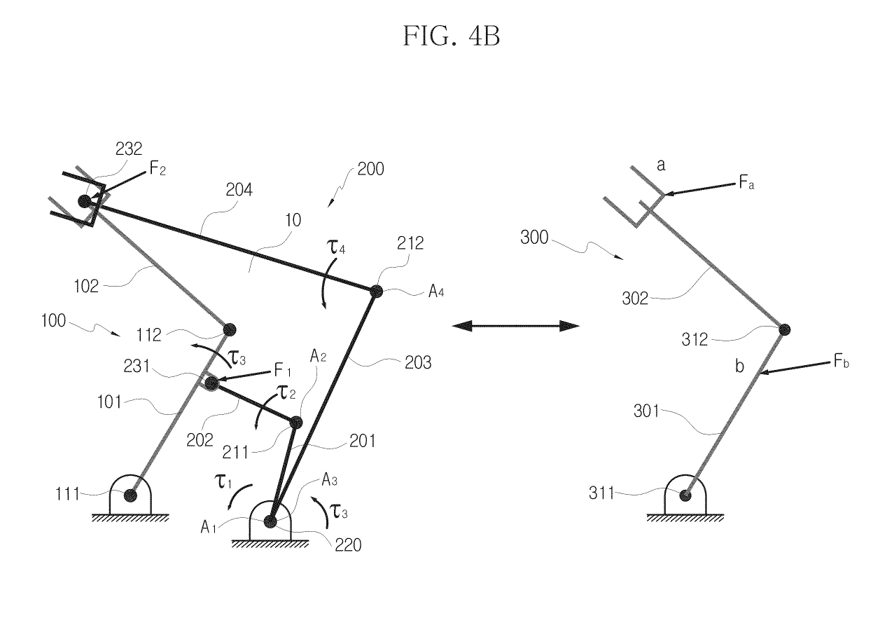

FIGS. 4A and 4B show a linkage mechanism 200 according to another embodiment of the present disclosure.

Referring to FIG. 4A, in the linkage mechanism 200 of this embodiment, a link arm 202 connected to the upper fixing portion 231 and a link arm 204 connected to the lower fixing portion 232 are connected to each other by link arms 201, 203 connected to a connection unit 220 which fixes the linkage mechanism 200 to a support member, thereby forming a closed loop 10 including the upper fixing portion 231, the lower fixing portion 232 and the connection unit 220. Meanwhile, the first link arm 201 and the second link arm 202 are connected to form a closed loop connecting the connection units 231, 211, 220 and the shoulder joint 111 together with the second body 101. Therefore, the linkage mechanism of this embodiment is attached to a user in a state where two closed loops are connected in parallel.

The connection unit 211 and the connection unit 212 respectively include a single actuator A2, A4, and the connection unit 220 includes two independent actuators A1, A3. In this embodiment, the upper fixing portion 231 does not have an actuator.

According to this embodiment, Equation 4 below is used for calculating a torque applied by an actuator A1, A2, A3, A4 of each connection unit.

$$[ \begin{matrix}{τ}_{1} \\ {τ}_{2} \\ {τ}_{3} \\ {τ}_{4}\end{matrix} ] = [ \begin{matrix}{J}_{11} & {J}_{21} & 0 & 0 \\ {J}_{12} & {J}_{22} & 0 & 0 \\ 0 & 0 & {J}_{33} & {J}_{43} \\ 0 & 0 & {J}_{34} & {J}_{44}\end{matrix} ] [ \begin{matrix}{F}_{1 x} \\ {F}_{1 y} \\ {F}_{2 x} \\ {F}_{2 y}\end{matrix} ] \qquad Equation 4$$

Referring to FIG. 4B, if the force sensor measures that the external force (F_{b}) is applied only to the second robot body 301 of the robot arm 300, the controller (not shown) of the linkage mechanism 200 receives the information and calculates the force (F₁). At this time, the force (F₁) is calculated as x component (F₁ₓ) and y component (F_{1y}), respectively. According to the relation of Equation 4, the controller of the linkage mechanism 200 operates the actuator A1 to output the obtained torque (τ₁) and operates the actuator A2 to output the obtained torque (τ₂). Meanwhile, the actuator A3 and the actuator A4 are not operated.

By doing so, in the human arm 100, the force (F₁) is applied only to the upper fixing portion 231, and no force is applied to the lower fixing portion 232. Therefore, if the force is applied to the upper fixing portion 231, the user may feel the force and thus may understand that a force is applied to a point of the second robot body 301 of the robot arm 300 remotely controlled.

Meanwhile, if it is measured that the external force (Fₐ) is applied to the third robot body 302 of the robot arm 300, the controller (not shown) of the linkage mechanism 200 calculates the force (F₂). At this time, the force (F₂) is calculated as x component (F₂ₓ) and y component (F_{2y}), respectively.

In this case, in Equation 4, the F₁ component becomes 0 so that the torque CO and the torque (τ₂) become 0, and the torque (τ₃) and the torque (τ₄) are calculated.

Therefore, the controller of the linkage mechanism 200 operates the actuator A3 to output the obtained torque (τ₃) and operates the actuator A4 to output the obtained torque (τ₄). The actuator A1 and the actuator A2 are not operated.

By doing so, in the human arm 100, the force (F₂) may be applied only to the lower fixing portion 232, and no force may be applied to upper fixing portion 231. Therefore, if the user may feel the force, the user may understand that a force is applied to a point of the third robot body 302 of the robot arm 300 remotely controlled.

Finally, if it is measured that the external force (F_{b}) and the external force (Fₐ) are simultaneously applied to the second robot body 301 and the third robot body 302 of the robot arm 300, respectively, the controller (not shown) of the linkage mechanism 200 calculates the force (F₁) and the force (F₂). At this time, the forces are respectively calculated as x component and y component.

In this case, all of the torque (τ₁) to torque (τ₄) are calculated by Equation 4. Therefore, the controller of the linkage mechanism 200 operates the actuator A1 to output the obtained torque (τ₁), operates the actuator A2 to output the obtained torque (τ₂), operates the actuator A3 to output the obtained torque (τ₃), and operates the actuator A4 to output the obtained torque (τ₄).

By doing so, the feeling of the force (F₁) applied to the upper fixing portion 231 and the feeling of the force (F₂) applied to the lower fixing portion 232 are transferred to the human arm 100. If the user feeds the forces, the user may understand that forces are simultaneously applied to points of the second robot body 301 and the third robot body 302 of the robot arm 300 remotely controlled.

Meanwhile, even though the above embodiments have been illustrated in a way that the link arms are connected by a hinge and the toque actuator is used as the actuator, the present disclosure is not limited thereto.

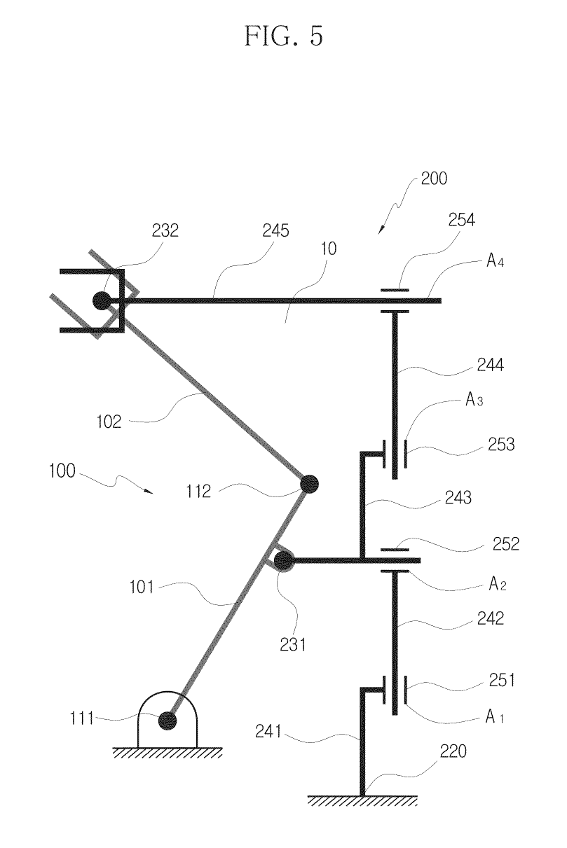

FIG. 5 shows a linkage mechanism 200 according to another embodiment of the present disclosure.

As shown in FIG. 5, according to this embodiment, a plurality of connection units 251, 252, 253, 254 is a connection unit which allows two link arms connected thereto to make linear movement in a horizontal or vertical direction, and it is a cylindrical connection unit where a link arm is inserted into a cylinder of another link arm. An actuator provided at the connection unit corresponding thereto is a length actuator which restricts movement of the link arm inserted into the cylinder.

In FIG. 5, if the user maintains the angle of the elbow joint 112 and moves the shoulder joint 111 to the right, the vertical link of the link arm 243 with a “T” shape moves to the right in the cylinder of the link arm 242. Simultaneously, the link arm 242 moves downwards in the cylinder of the link arm 241. By this configuration, it may be understood that, unless an external force is applied, the link arms may adaptively move according to a motion of a human by means of the cylindrical connection unit.

Referring to FIG. 2 again in view of FIG. 5, operations of this embodiment which gives a feeling of force to a user will be described.

First, if the force sensor measures that the external force (F_{b}) is applied only to the second robot body 301 of the robot arm 300, the controller (not shown) of the linkage mechanism 200 receives the information and scales the external force (F_{b}) at a preset ratio to calculate the force (F₁). At this time, the force (F₁) is calculated as x component (F₁ₓ) and y component (F_{1y}), respectively.

The controller of the linkage mechanism 200 operates the actuator A1 to push the link arm 242 vertically so as to output a vertical force corresponding to the x component force (F₁ₓ). In addition, the controller operates the actuator A2 to pushes the link arm 243 horizontally so as to output a horizontal force corresponding to the y component force (F_{1y}). At this time, the actuator A3 and the actuator A4 are not operated.

By doing so, the feeling of the force (F₁) applied to the upper fixing portion 231 is transferred to the human arm 100, and no force is applied to the lower fixing portion 232. Therefore, if the user feels the force applied only to the upper fixing portion 231, the user may understand that a force is applied to a point of the second robot body 301 of the robot arm 300 remotely controlled.

Next, if it is measured that the external force (Fₐ) is applied to the third robot body 302 of the robot arm 300, the controller (not shown) of the linkage mechanism 200 receives the information and scales the external force (Fₐ) at a preset ratio to calculate the force (F₂). At this time, the force (F₂) is calculated as x component (F₂ₓ) and y component (F_{2y}), respectively.

The controller of the linkage mechanism 200 operates the actuator A1 and the actuator A3 to push the link arm 242 and the link arm 244 vertically so as to output a vertical force corresponding to the x component force (F₁ₓ). At this time, the intensities of the forces applied by the actuator A1 and the actuator A3 are suitably adjusted by a mechanical model of the linkage mechanism 200.

In addition, the controller operates the actuator A2 and the actuator A4 to push the link arm 243 and the link arm 245 horizontally so as to output a horizontal force corresponding to the y component force (F_{1y}). At this time, the intensities of the forces applied by the actuator A2 and the actuator A4 are suitably adjusted by a mechanical model of the linkage mechanism 200.

By doing so, in the human arm 100, the force (F₂) may be applied to the lower fixing portion 232, and no force may be applied to the upper fixing portion 231. Therefore, if the user feels the force, the user may understand that a force is applied to a point of the third robot body 302 of the robot arm 300 remotely controlled.

Finally, if it is measured that the external force (F_{b}) and the external force (Fₐ) are simultaneously applied to the second robot body 301 and the third robot body 302 of the robot arm 300, the controller (not shown) of the linkage mechanism 200 receives the information, scales the external force (F_{b}) at a preset ratio to calculate the force (F₁) and scales the external force (Fₐ) at a preset ratio to calculate the force (F₂). At this time, the forces are respectively calculated as x component and y component.

The controller of the linkage mechanism 200 operates the actuator A1 and the actuator A3 to push the link arm 242 and the link arm 244 vertically so as to output a vertical force corresponding to the x component force (F₁ₓ). At this time, the intensities of the forces applied by the actuator A1 and the actuator A3 are suitably adjusted by a mechanical model of the linkage mechanism 200.

In addition, the controller operates the actuator A2 and the actuator A4 to push the link arm 243 and the link arm 245 horizontally so as to output a horizontal force corresponding to the y component force (F_{1y}). At this time, the intensities of the forces applied by the actuator A2 and the actuator A4 are suitably adjusted by a mechanical model of the linkage mechanism 200.

By doing so, the feeling of the force (F₁) applied to the upper fixing portion 231 and the feeling of the force (F₂) applied to the lower fixing portion 232 are transferred to the human arm 100. If the user feels the forces, the user may understand that forces are simultaneously applied to points of the second robot body 301 and the third robot body 302 of the robot arm 300.

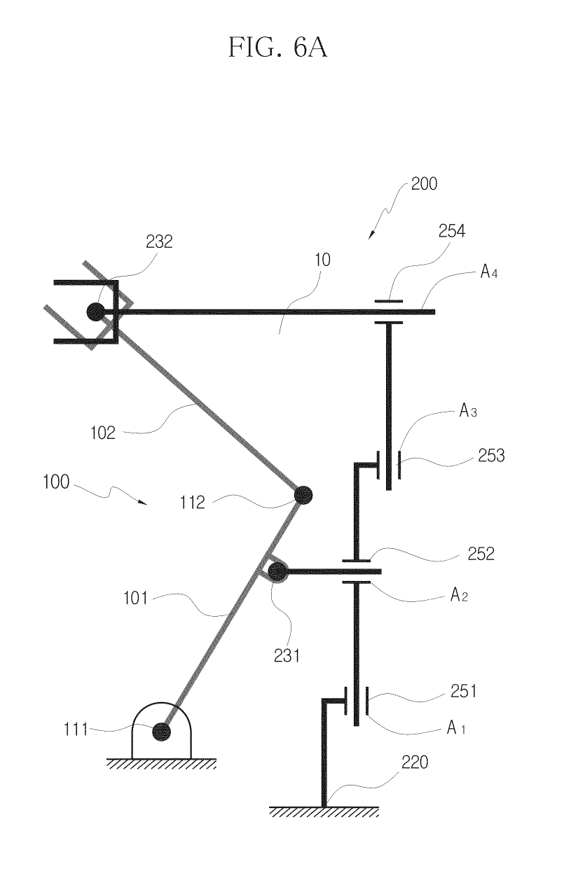

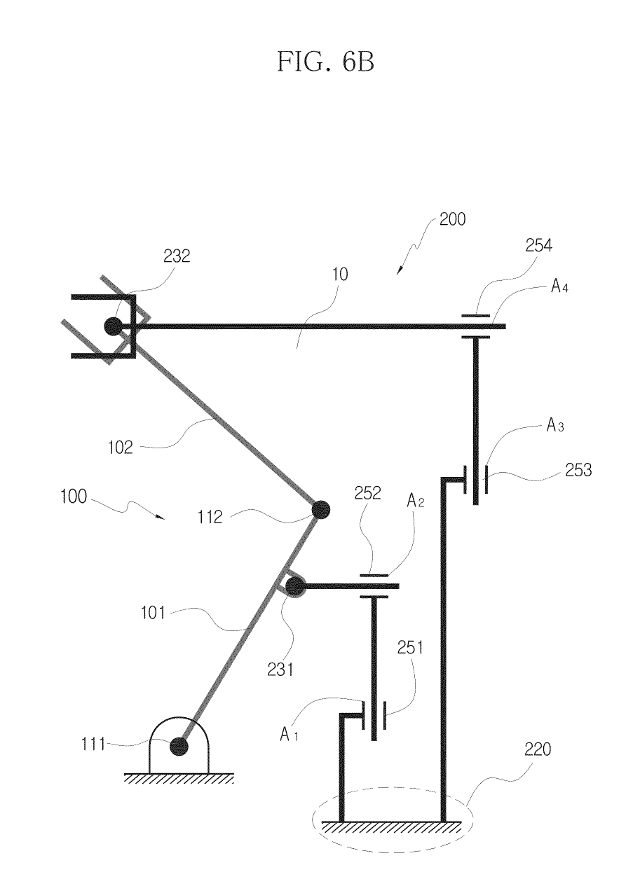

FIGS. 6A and 6B show a linkage mechanism 200 according to another embodiment of the present disclosure.

Referring to the embodiment shown in FIG. 6A, the linkage mechanism 200 has a configuration corresponding to the linkage mechanism 200 of FIG. 3 in the point that the linkage arm connected to the upper fixing portion 231 and the link arm connected to the lower fixing portion 232 are connected to each other via another link arm to form a closed loop 10.

The method and principle of providing a user with the feeling of force, employed in this embodiment, may be clearly understood from the former embodiments by those having ordinary skill in the art and thus they are not described in detail here.

According to the embodiment shown in FIG. 6B, the linkage mechanism 200 has a configuration corresponding to the linkage mechanism 200 of FIG. 4 in the point that the link arm connected to the upper fixing portion 231 and the link arm connected to the lower fixing portion 232 are connected to each other by link arms connected to the connection unit 220 which fixes the linkage mechanism 200 to the support member, thereby forming a closed loop 10 including the upper fixing portion 231, the lower fixing portion 232 and the connection unit 220.

The method and principle of providing a user with the feeling of force, employed in this embodiment, may be clearly understood from the former embodiments by those having ordinary skill in the art and thus they are not described in detail here.

Meanwhile, according to another embodiment of the present disclosure, the plurality of connection units of the linkage mechanism 200 may be configured with a combination of the hinge-type connection units (see FIG. 1) and the cylindrical connection units (see FIG. 5), and the actuator may employ a torque actuator or a length actuator according to the form of each connection unit.

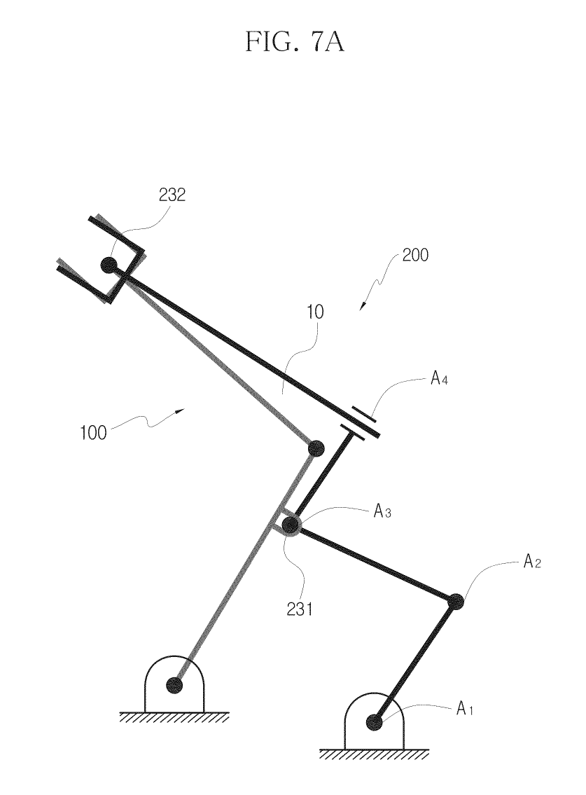

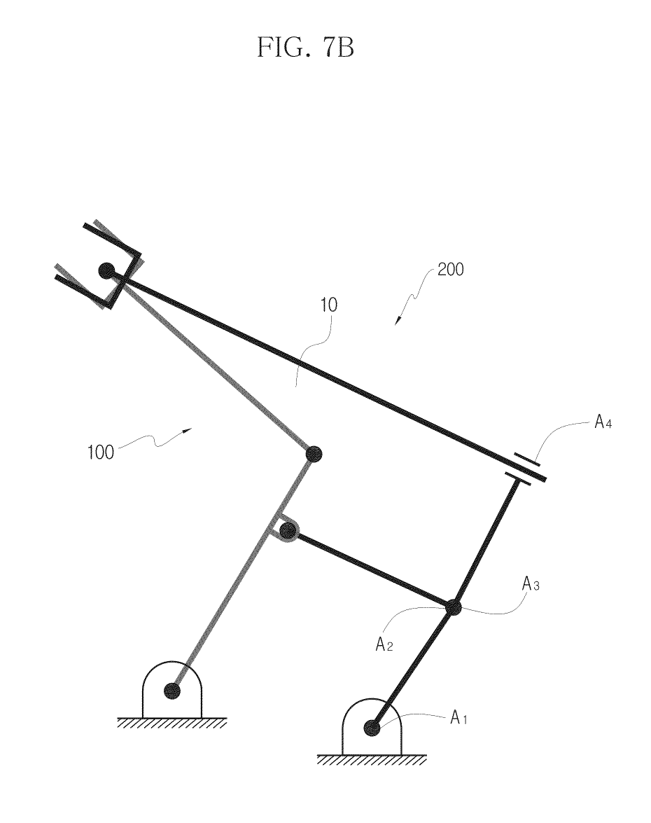

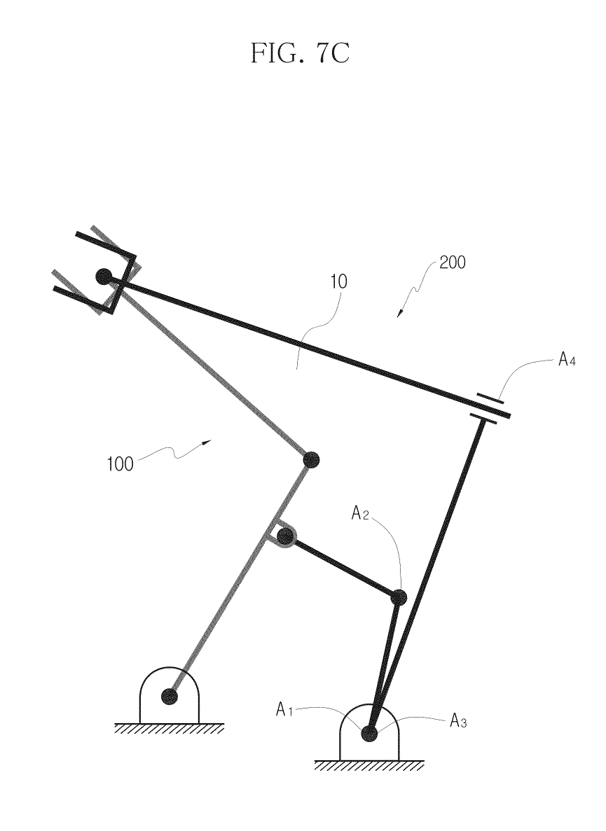

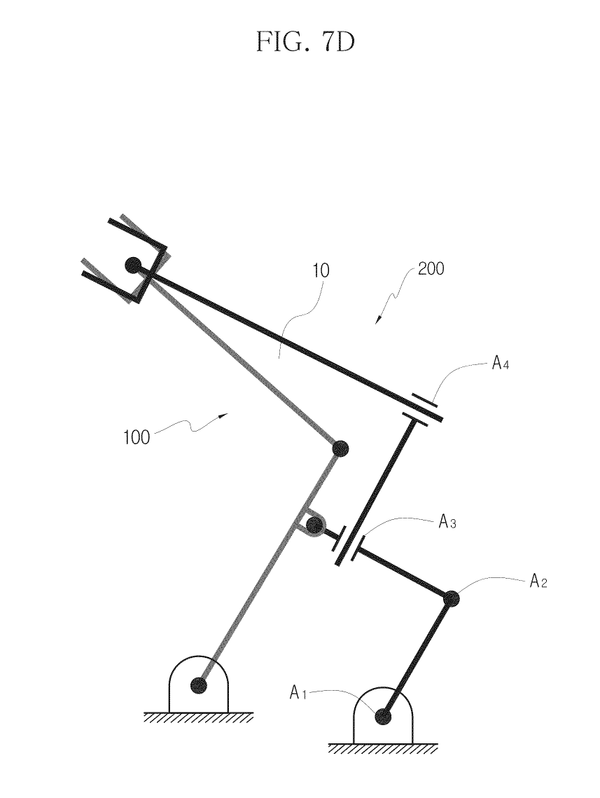

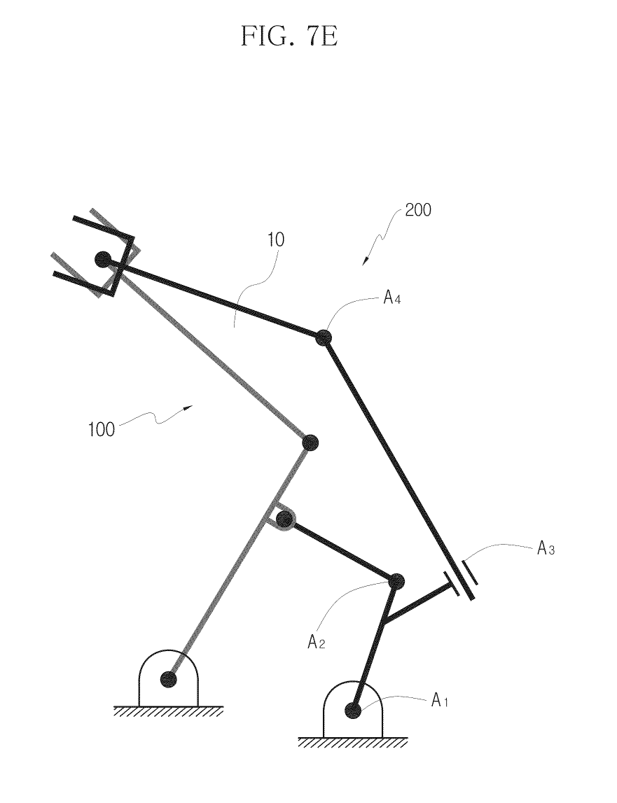

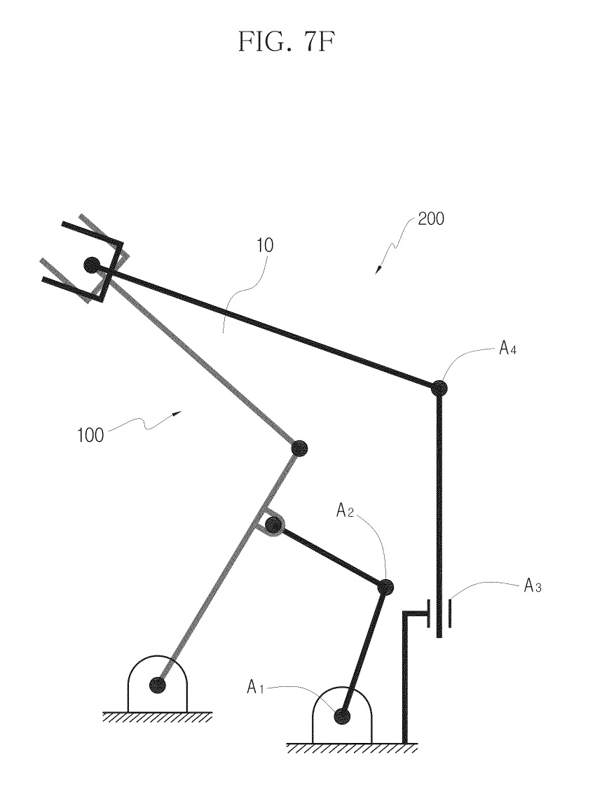

FIGS. 7A to 7F show the above embodiments.

It may be understood that the linkage mechanisms 200 shown in FIGS. 7A and 7D have configurations corresponding to the linkage mechanism 200 of FIG. 1, the linkage mechanisms 200 shown in FIGS. 7B and 7E have configurations corresponding to the linkage mechanism 200 of FIG. 3, and the linkage mechanisms 200 shown in FIGS. 7C and 7F have configurations corresponding to the linkage mechanism 200 of FIG. 4.

The operations of the linkage mechanisms 200 shown in FIGS. 7A to 7F may be understood based on the force feeling providing mechanism according to the operations of the torque actuator and the length actuator by those having ordinary skill in the art, and so operations of each component will not be described in detail here.

In addition to the configurations shown in FIGS. 7A to 7F, it should be understood that more combinations may be used where the plurality of connection units of the linkage mechanism is configured with a combination of the hinge-type connection unit and the cylindrical connection unit and the actuator employs a torque actuator or a length actuator corresponding to the form of each connection unit, while using the technical aspect of the present disclosure.

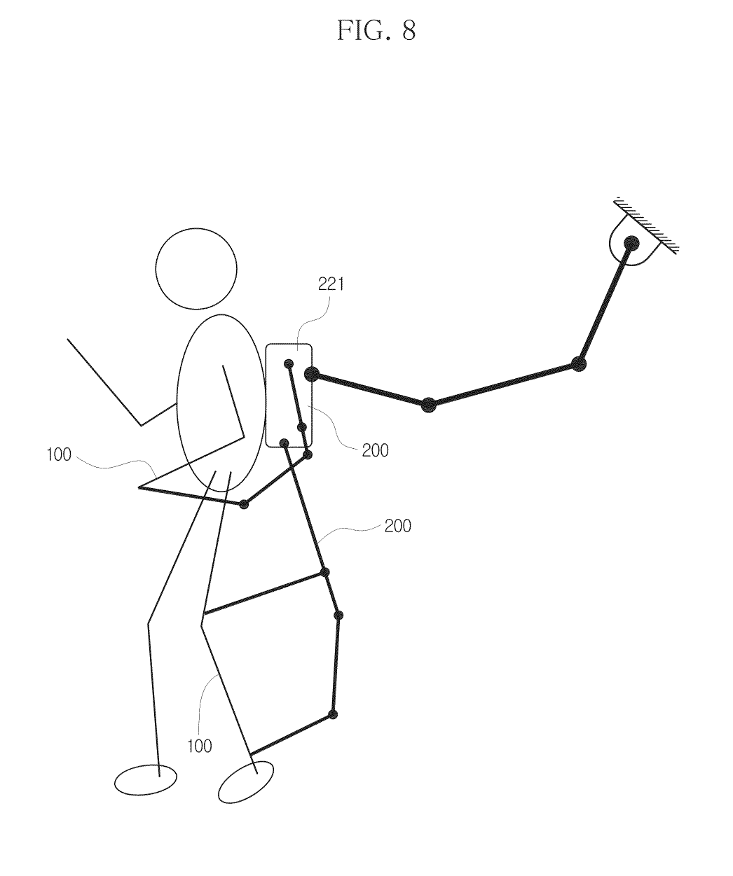

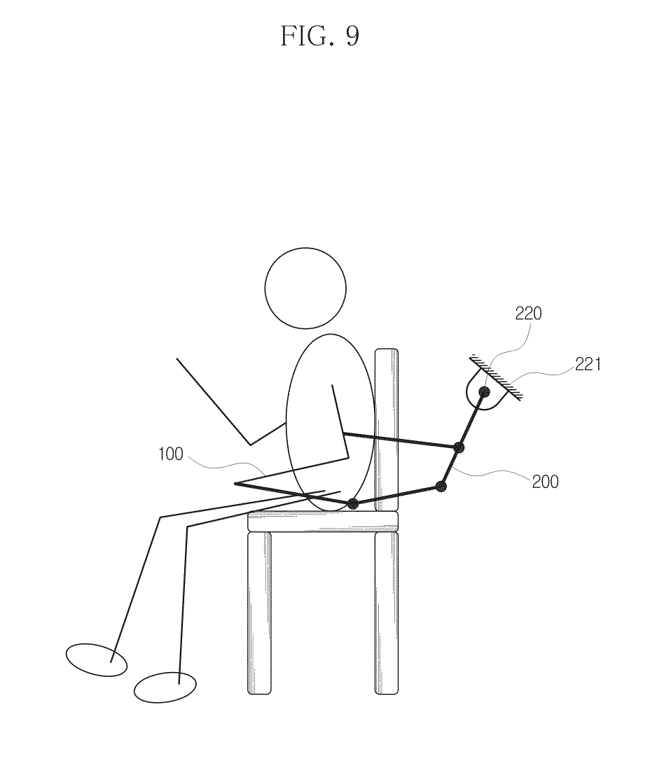

FIGS. 8 and 9 are schematic diagrams showing the linkage mechanism 200 according to an embodiment of the present disclosure, worn by a human.

As shown in FIG. 8, while loading a bag-type support member 221 having a power supply device on the back, a user may mount the linkage mechanism 200 connected to the support member 221 to the arm or leg 100. According to this embodiment, the user may control a robot while moving together with the robot.

In FIG. 8, the linkage structure extending long to the rear of the support member 221 is a configuration for supporting the weight of the support member 221 when the support member 221 has a great weight, which is different from the linkage mechanism 200 of the present disclosure.

As shown in FIG. 9, a user may adjust the arm of a robot by using the linkage mechanism 200 connected to the arm while seating on a chair or the like. At this time, the support member 221 becomes a structure like a wall, and the connection unit 220 is formed at the support member 221.

Even though it has been described that a robot is adjusted by using the linkage mechanism 200 according to the embodiments of the present disclosure, the use of the present disclosure is not limited thereto. For example, the linkage mechanism 200 according to the embodiments of the present disclosure may be used for moving various characters and providing more realistic virtual environments by allow a user to directly feel an external force or the like applied to a character.

While the exemplary embodiments have been shown and described, it will be understood by those skilled in the art that various changes in form and details may be made thereto without departing from the spirit and scope of the present disclosure as defined by the appended claims.

What is claimed is:

1. A linkage mechanism, coupled to a limb of a human including a second body articulated to a first body and a third body articulated to the second body, the linkage mechanism comprising:
a plurality of link arms and a plurality of connection units for connecting the link arms to be adaptively movable according to a motion of the human; and
an upper fixing portion and a lower fixing portion for fixing the linkage mechanism to the second body and the third body,
wherein all or a part of the plurality of link arms are connected to each other to form a closed loop including the upper fixing portion and the lower fixing portion together with the second body and the third body,
wherein actuators for generating power are provided to the plurality of connection units, and
wherein the actuators are selectively operated to apply a force selectively to the upper fixing portion and the lower fixing portion.

2. The linkage mechanism according to claim 1,
wherein the linkage mechanism is a linkage mechanism for remotely controlling a limb of a robot including a second robot body articulated to a first robot body and a third robot body articulated to the second robot body,
wherein the linkage mechanism is controlled to apply a force to the upper fixing portion when an external force is applied to the second robot body, and
wherein the linkage mechanism is controlled to apply a force to the lower fixing portion when an external force is applied to the third robot body.

3. The linkage mechanism according to claim 1,
wherein the link arm connected to the upper fixing portion and the link arm connected to the lower fixing portion are connected to each other to form a closed loop.

4. The linkage mechanism according to claim 1,
wherein the link arm connected to the upper fixing portion and the link arm connected to the lower fixing portion are connected via another link arm to form a closed loop.

5. The linkage mechanism according to claim 1,
wherein the link arm connected to the upper fixing portion and the link arm connected to the lower fixing portion are connected through link arms connected to a connection unit which fixes the linkage mechanism to a support surface, and
wherein a closed loop including the upper fixing portion, the lower fixing portion and the connection unit for fixing the linkage mechanism to the support member is formed.

6. The linkage mechanism according to claim 1,
wherein the plurality of connection units includes a displacement measuring sensor for measuring a displacement of the connection unit.

7. The linkage mechanism according to claim 1,
wherein the plurality of connection units is each a hinge-type connection unit which connects two link arms by a hinge, and
wherein the actuator is a torque actuator for rotating the hinge-type connection unit to generate a torque.

8. The linkage mechanism according to claim 1,
wherein the plurality of connection units is each a cylindrical connection unit where a link arm is inserted into a cylinder of another link arm so that both link arms are linearly movable, and
wherein the actuator is a length actuator for restricting movement of the link arm inserted into the cylinder.

9. The linkage mechanism according to claim 1,
wherein the plurality of connection units is configured as a combination of a hinge-type connection unit which connects two link arms to each other by a hinge and a cylindrical connection unit where a link arm is inserted into a cylinder of another link arm so that both link arms are linearly movable, and
wherein the actuator is a torque actuator for rotating the hinge-type connection unit to generate a torque or a length actuator for restricting movement of the link arm inserted into the cylinder.
